(19) United States
(12) Patent Application Publication
(10) Pub. No.: US 2012/0082838 A1
(43) Pub. Date: Apr. 5, 2012

(54) BARRIER FILM OR FABRIC

(75) Inventors: Hua Fan, Nashua, NH (US); Michael J. Lussier, Bedford, NH (US)

(73) Assignee: SAINT-GOBAIN PERFORMANCE PLASTICS CORPORATION, Aurora, OH (US)

(21) Appl. No.: 13/249,138

(22) Filed: Sep. 29, 2011

Related U.S. Application Data
(60) Provisional application No. 61/387,869, filed on Sep. 29, 2010.

(51) Int. Cl. B32B 27/08; B32B 5/26; B32B 27/32; B32B 7/00; B32B 27/34; B32B 27/40

(52) U.S. Cl. 428/221; 428/473.5; 428/421; 428/422; 428/423.1; 428/500

(57) ABSTRACT

A multilayer construction includes a barrier layer having first and second major surfaces and including a polyimide material, a first outer layer directly bonded to and in direct contact with the first major surface of the barrier layer, and a second outer layer directly bonded to an in direct contact with the second major surface of the barrier layer. The first and second outer layer including a thermoplastic polymer. The first and second outer layers form first and second opposite outer surfaces of the multilayer construction.

### CROSS REFERENCE TO RELATED APPLICATION(S)

The present application claims priority from U.S. Provisional Patent Application No. 61/387,869, filed Sep. 29, 2010, entitled “BARRIER FILM OR FABRIC,” naming inventors Hua Fan and Michael J. Lussier, which application is incorporated by reference herein in its entirety.

### FIELD OF THE DISCLOSURE

This disclosure in general relates to films and fabrics that have barrier properties and methods for making such films and fabrics.

### BACKGROUND

Increasingly, industry uses films and fabrics to form large configuration products or continuous belts. For example, large coverings can be formed from fabrics. In another example, large enclosed volumes, such as inflatable objects for advertising or entertainment or large flexible containers, can be formed from films or fabrics. In a further example, such films or fabrics can be used in continuous belt applications.

A conventional thermoplastic film or coated fabric can bond to itself or another film or fabric to form seams. In such a manner, conventional thermoplastic films or coated fabrics can be used to form large configuration product and complex geometries using thermal sealing and bonding techniques.

However, such conventional thermoplastic films exhibit poor barrier properties and exhibit poor chemical resistance. Poor barrier properties can lead to contamination of products in a container, undesirable release of gasses, or undesirable transfer of water vapor. As such, an improved thermoplastic film or coated fabric would be desirable.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary multilayer film.

FIG. 2, FIG. 3, FIG. 4, and FIG. 5 include illustrations of exemplary coated fabrics.

FIG. 6 and FIG. 7 include flow chart illustrations of exemplary methods for forming a film or coated fabric.

The use of the same reference symbols in different drawings indicates similar or identical items.

### DETAILED DESCRIPTION

In an exemplary embodiment, a multilayer structure, such as a fabric or film, includes a barrier layer and a thermoplastic layer in direct contact with a major surface of the barrier layer. For example, the barrier layer can include a fluoropolymer. Such a fluoropolymer layer can be surface treated with a corona treatment. In another example, the barrier layer can include polyimide. The thermoplastic layer can include a polyolefin or a thermoplastic urethane, among others. In addition, a fabric can include a reinforcement material, such as a woven fibrous material. One of the barrier layer or thermoplastic layer can be coated on one or both sides of the reinforcement material.

In another exemplary embodiment, a method of forming the film or fabric includes treating a major surface of a polymer film or coated fabric with a corona treatment and laminating a thermoplastic film to the polymer film or coated fabric. The method can also include coating a fibrous material, such as a woven fibrous material, with a fluoropolymer or thermoplastic.

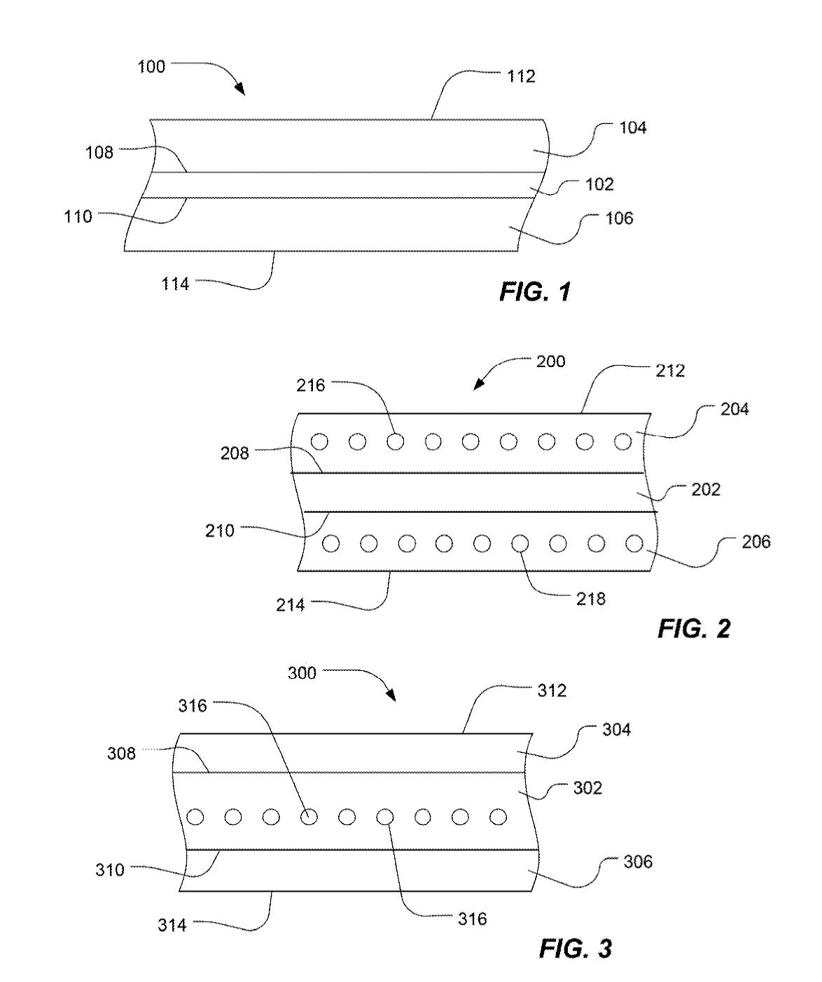

FIG. 1 includes an illustration of an exemplary embodiment of a multilayer construction 100 including a barrier layer 102 having a first outer layer 104 disposed on a major surface 108 of the barrier layer 102. Optionally, the multilayer film 100 can include a second outer layer 106 disposed on a second major surface 110 and opposite the first outer layer 104. The outer layer 104 forms an outer surface 112 and the outer layer 106 forms the outer surface 114.

In a particular example, the barrier layer 102 is directly bonded to the outer layer 104, such as without intervening layers. Further, the barrier layer 102 may be free of bond enhancing fillers, such as metal oxides including, for example, silica.

The barrier layer 102 can include a polymer, such as a polyester, a fluoropolymer, a polyimide, or any combination thereof. In an example, the polyester is a polyolefin terephthalate, such as polyethylene terephthalate. In another example, the polyester is a liquid crystal polymer. An exemplary liquid crystal polymer includes aromatic polyester polymers, such as those available under tradenames XYDAR® (Amoco), VECTRA® (Hoechst Celanese), SUMIKOSUPER™ or EKONOL™ (Sumitomo Chemical), DuPont HX™ or DuPont ZENITE™ (E.I. DuPont de Nemours), RODRUN™ (Unitika), GRANLAR™ (Grandmont), or any combination thereof. Preferred liquid crystal polymers include thermotropic (melt processable) liquid crystal polymers wherein constrained microlayer crystallinity can be particularly advantageous.

In an example, the fluoropolymer can include a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof. For example, the fluoropolymer can include polyvinylidene fluoride (PVDF), polyvinyl fluoride (PVF), polytetrafluoroethylene (PTFE) ethylene tetrafluoroethylene copolymer (ETFE), polychlorotrifluoroethylene (PCTFE), ethylene chlorotrifluoroethylene copolymer (ECTFE), fluorinated ethylene propylene copolymer (FEP),a copolymer of ethylene and fluorinated ethylene propylene (EFEP), a terpolymer of tetrafluoroethylene, hexafluoropropylene, and vinylidene fluoride (THV), a terpolymer of tetrafluoroethylene, hexafluoropropylene, and ethylene (HTE), a copolymer of tetrafluoroethylene and perfluoromethyl vinyl ether (MFA), or any combination thereof. In a particular example, the fluoropolymer is polytetrafluoroethylene (PTFE). In another example, the fluoropolymer includes ETFE, FEP, PVDF, or any combination. Exemplary fluoropolymers films may be cast, skived, or extruded.

In another example, the barrier layer 102 includes polyimide. An exemplary polyimide is formed through the imidization of a polyamic acid derived from the reaction of one or more diamines with one or more dianhydrides. An exemplary dianhydride includes pyromellitic dianhydride (PMDA), 2,3,6,7-naphthalenetetracarboxylic acid dianhydride, 3,3′,4,4′-diphenyltetracarboxylic acid dianhydride, 1,2,5,6-naphthalenetetracarboxylic acid dianhydride, 2,2′,3,3′-diphenyltetracarboxylic acid dianhydride, 2,2-bis-(3,4-dicarboxyphenyl)-propane dianhydride, bis-(3,4-dicarboxyphenyl)-sulfone dianhydride, bis-(3,4-dicarboxyphenyl)-ether dianhydride, 2,2-bis-(2,3-dicarboxyphenyl)-propane dianhydride, 1,1-bis-(2,3-dicarboxyphenyl)-ethane dianhydride, 1,1-bis-(3,4-dicarboxyphenyl)-ethane dianhydride, bis-(2,3-dicarboxyphenyl)-methane dianhydride, bis-(3,4-dicarboxyphenyl)-methane dianhydride, 3,4,3′,4′-benzophenonetetracarboxylic acid dianhydride, or any mixture thereof. In a particular example, the dianhydride is pyromellitic dianhydride (PMDA). In another example, the dianhydride is benzophenonetetracarboxylic acid dianhydride (BTDA) or diphenyltetracarboxylic acid dianhydride (BPDA).

An exemplary diamine includes oxydianiline (ODA), 4,4′-diaminodiphenylpropane, 4,4′-diaminodiphenylmethane, 4,4′-diaminodiphenylamine, benzidine, 4,4′-diaminodiphenyl sulfide, 4,4′-diaminodiphenyl sulfone, 3,3′-diaminodiphenyl sulfone, 4,4′-diaminodiphenyl ether, bis-(4-aminophenyl)diethylsilane, bis-(4-aminophenyl)-phenylphosphine oxide, bis-(4-aminophenyl)-N-methylamine, 1,5-diaminonaphthalene, 3,3′-dimethyl-4,4′-diaminobiphenyl, 3,3′-dimethoxybenzidine, 1,4-bis-(p-aminophenoxy)-benzene, 1,3-bis-(p-aminophenoxy)-benzene, m-phenylenediamine (MPD), p-phenylenediamine (PPD), or any mixture thereof. In a particular example, the diamine is oxydianiline (ODA), such as 3,4′-oxydianiline or 4,4′-oxydianiline. In particular, the ODA may be 4,4′-oxydianiline. In another example, the diamine is m-phenylenediamine (MPD), p-phenylenediamine (PPD), or any combination thereof. For example, a dianhydride, such as pyromellitic dianhydride (PMDA) or diphenyltetracarboxylic acid dianhydride (BPDA), may be reacted with two or more diamines selected from oxydianiline (ODA), m-phenylenediamine (MPD), or p-phenylenediamine (PPD).

In an embodiment, a major surface 108 or 110 of the barrier layer 102 can be treated. For example, the barrier layer 102 may be treated to improve adhesion of the barrier layer 102 to the layer it directly contacts. In an embodiment, the treatment may include surface treatment, chemical treatment, sodium etching, use of a primer, or any combination thereof. In an embodiment, the treatment may include corona treatment, UV treatment, electron beam treatment, flame treatment, scuffing, sodium naphthalene surface treatment, or any combination thereof. In an example, the treatment includes corona treatment. In another example, the corona treatment includes C-treatment. For C-treatment, the fluoropolymer layer is exposed to a corona discharge in an organic gas atmosphere, wherein the organic gas atmosphere comprises, for example, acetone or an alcohol. For example, the alcohol can include four carbon atoms or less. In an example, the organic gas is acetone. The organic gas can be admixed with an inert gas such as nitrogen. The acetone/nitrogen atmosphere causes an increase of adhesion of the fluoropolymer layer to the layer that it directly contacts. In a particular example, the treatment causes an increase of adhesion of a barrier layer 102 to other polymeric layers.

In an exemplary embodiment, the treatment includes C-treatment of a C-treatable fluoropolymer. For example, at least one surface of the fluoropolymer may include a C-treatable fluoropolymer. Exemplary C-treatable fluoropolymers include fluorinated ethylene propylene copolymer (FEP), a copolymer of ethylene tetrafluoroethylene (ETFE), a copolymer of tetrafluoroethylene and perfluoropropyl vinyl ether (PFA), a copolymer of ethylene and chlorotrifluoroethylene (ECTFE), a copolymer of tetrafluoroethylene and perfluoromethyl vinyl ether (MFA), poly vinylidene fluoride (PVDF), polyvinyl fluoride (PVF), polychlorotrifluoroethylene, polytetrafluoroethylene (PTFE), a terpolymer including tetrafluoroethylene, hexafluoropropylene, and vinylidenefluoride (THV), or any combination thereof. In an embodiment, the fluoropolymer has a first major surface and a second major surface where the first and second major surfaces include the same or different C-treatable fluoropolymers. An exemplary PTFE may be obtained from Saint-Gobain Performance Plastics Corporation, such as DF1700 DB.

The outer layers 104 or 106 can be formed of a polymeric material, such as a thermoplastic material or a thermoset material. An exemplary polymeric material may include polyamide, polyaramide, polyimide, polyolefin, polyvinylchloride (PVC), acrylic polymer, diene monomer polymer, polycarbonate (PC), polyetheretherketone (PEEK), polyester, polystyrene, polyurethane, thermoplastic blends, or any combination thereof. Further polymeric materials may include a silicone, a phenolic, an epoxy, or any combination thereof. In an example, the polymeric layer includes polyvinylchloride (PVC). In another example, the polymeric material includes polyurethane, such as a thermoplastic polyurethane. In a further example, the polymeric material includes a polyolefin, such as polyethylene (PE) such as high density polyethylene (HDPE), medium density polyethylene (MDPE), low density polyethylene (LDPE), ultra low density polyethylene, or any combination thereof; polypropylene (PP); polybutene; polypentene; polymethylpentene; ethylene octene copolymer; or any combination thereof. In a particular example, the polymeric material includes polyethylene, such as high density polyethylene (HDPE). In another example, the polymeric material includes a polyamide, such as Nylon®. For example, the polymeric material can have similar properties to PVC or polyurethane, including, for example, mechanical properties, flammability properties, bondable properties, and the like. In particular, a polymeric layer suitable for contact with a contained fluid or other material is envisioned.

The outer layers 104 or 106 may possess other properties specific to the intended use. For instance, the polymeric layer may contain polymeric fillers, mineral fillers, metallic fillers, or any combination thereof to change the appearance, abrasion resistance or other physical properties of the polymeric layer. In a particular embodiment, the polymeric layer may possess properties specifically intended for the embodiment when the polymeric layer(s) are the surface layer(s) of the multilayer structure. For example, it may be colored in any desired color. It may be textured for appearance or for low surface friction. In an example, the polymeric material may be stronger or more abrasion resistant than the fluoropolymer film underneath, thus maintaining barrier integrity in the face of physical stresses.

The barrier layer 102 can have a thickness of at least about 0.01 millimeters (mm). For example, the barrier layer 102 may have a thickness of about 0.02 millimeters to about 0.3 millimeters. In an example, the barrier layer 102 may have a thickness of about 0.01 millimeters to 0.05 millimeters. In another example, the barrier layer 102 may have a thickness of about 0.1 millimeters to about 0.3 millimeters.

The outer layer 104 or 106 can have a thickness of at least about 0.05 millimeters. For example, the outer layer 104 or 106 may have a thickness of about 0.2 millimeters to about 2.0 millimeters, such as about 0.2 millimeters to about 1.5 millimeters, such as about 0.2 millimeters to about 1.0 millimeters.

In a further embodiment, one or more of the layers can include reinforcement material. The reinforcement material may be disposed in any position within the structure to provide reinforcement to the structure. In an example, the reinforcement material may be disposed between the barrier layer 102 and the outer layers 104 or 106. In another example, the reinforcement material may be substantially embedded in the outer layer 104 or 106. “Substantially embedded” as used herein refers to a reinforcing layer wherein at least 25%, such as at least about 50%, or even 100% of the total surface area of the reinforcement material is embedded in a layer such as the outer layer 104 or 106 or the barrier layer 102. In an embodiment, at least about 25%, or even about 50%, or even about 100% of the outer layer 104 or 106 is directly in contact with the barrier layer 102 and the reinforcement material is disposed in one or both of the outer layer 104 or 106 or the barrier layer 102.

The reinforcement material can be any material that increases the reinforcing properties of the structure 100. For instance, the reinforcement material may include natural fibers, synthetic fibers, or combination thereof. In an example, the fibers may be in the form of a knit, laid scrim, braid, woven, or non-woven fibrous material. Exemplary reinforcement fibers include glass, aramids, polyamides, polyesters, and the like. In an embodiment, the reinforcing layer may be selected in part for its effect on the surface texture of the multilayer structure formed. The reinforcing layer may have a thickness of less than about 5.0 mm, such as not greater than about 2.0 mm.

In an embodiment, the barrier layer 102 includes a fluoropolymer. For example, the barrier layer 102 can be formed of PTFE. In another example, the barrier layer 102 can be formed of PVDF. In a further example, the barrier layer 102 can be formed of PVF. In an additional example, the barrier layer 102 can be formed of ETFE. In each of these examples, the surface of the fluoropolymer to contact an outer layer 104 or 106 can be treated, such as corona treated or C-treated. In addition, the outer layer 104 or 106 can be formed of a thermoplastic. The thermoplastic can be polyurethane. In another example, the thermoplastic can be a polyolefin, such as polyethylene. In a further example, the thermoplastic can be an amide thermoplastic.

In another embodiment, the barrier layer 102 can be formed of a polyimide film and the outer layers 104 or 106 can be formed of a polyolefin, a polyurethane, or an amide. For example, the outer layers 104 or 106 can be formed of a polyurethane. In another example, the outer layers 104 or 106 can be formed of a polyolefin.

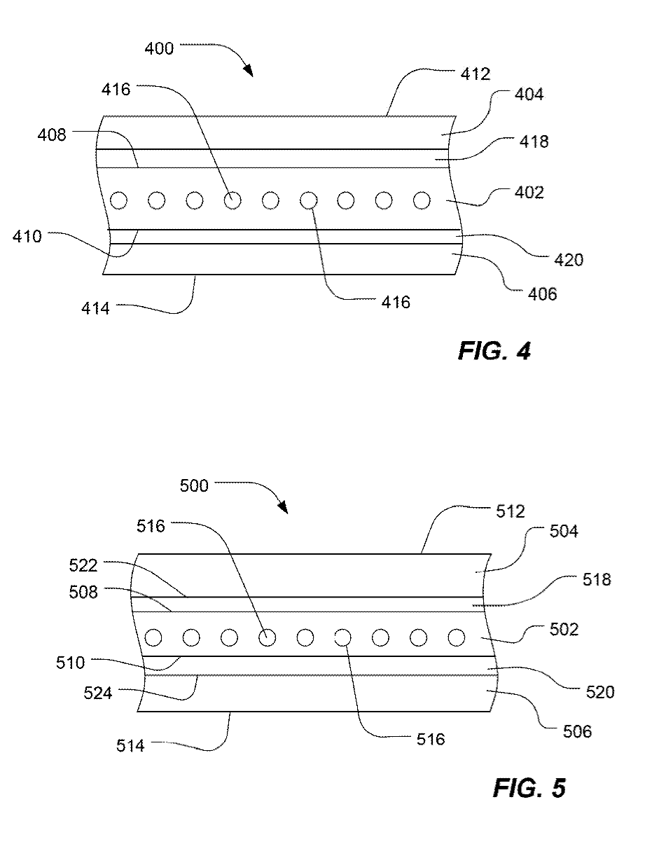

In a particular embodiment of a multilayer structure 200 illustrated in FIG. 2, a reinforcement material 216 or 218 is disposed in an outer layer 204 or 206. As illustrated, the outer layer 204 is disposed on a major surface 208 of a barrier layer 202. Optionally, the outer layer 206 is disposed on a major surface 210 of the barrier layer 202. The outer layer 204 forms outer surface 212 of the multilayer structure 200, and the outer layer 206 forms outer surface 214 of the multilayer structure 200. Absent the outer layer 206, the barrier layer 202 can form the outer surface 214.

In an example, the barrier layer 202 can include a polymeric material, such as the polymers described in relation to barrier layer 102. In another example, the outer layer 204 or 206 can include a polymeric material, such as the thermoset polymer or thermoplastic polymer described in relation to outer layer 104 or 106.

A reinforcement material 216 or 218 can be embedded in the outer layer 204 or 206. The reinforcement material can be selected from a material having a configuration as described above. In a particular example, the reinforcement is entirely embedded in the outer layer 204 or 206. The outer layer 204 or 206 is in direct contact with the barrier layer 202, such as without any intervening layers.

In a particular embodiment, the outer layers 204 or 206 can be formed of a woven or knitted fibrous material coated with a thermoplastic polymer. In an example, the thermoplastic polymer can be polyurethane. In another example, the thermoplastic polymer can be a polyolefin. The woven or knitted fibrous material can be formed of fibers formed of fiberglass, polyamide, polyolefin, polyaramid, polyester, or any combination thereof. The barrier layer 202 can be formed of a barrier polymer, such as polyimide. In another example, the barrier polymer can include a fluoropolymer. The fluoropolymer can be ETFE. In another example, the fluoropolymer can be PVDF. In a further example, the fluoropolymer can be PVF. In a further example, the fluoropolymer can be PTFE.

In an alternative embodiment, the barrier layer can be formed on an outside layer of the construction. For example, FIG. 3 includes an illustration of a multilayer construction 300 including a polymer layer 302. A barrier layer 304 at interface 308 is bonded directly to the polymer layer 302. A barrier layer 306 at interface 310 can be bonded directly to the polymer layer 302. In this embodiment, the barrier layer 304 or 306 forms an outer surface 312 or 314, respectively. A reinforcement material 316 can be embedded in the polymer layer 302.

In an example, the barrier layer 304 or 306 includes a barrier polymer, such as the polymers described in relation to barrier layer 102. The barrier layer 304 or 306 can be treated, such as with a corona or C-treatment, at interface 308 or 310, respectively. In another example, the polymer layer 302 can include a polymeric material, such as the thermoset or thermoplastic polymer described in relation to outer layer 104 or 106. The reinforcement material can be selected from the reinforcement materials described above.

In a particular embodiment, the polymer layer 302 can be formed of a woven or knitted fibrous material coated with a thermoplastic polymer. In an example, the thermoplastic polymer can be polyurethane. In another example, the thermoplastic polymer can be a polyolefin. The woven or knitted fibrous material can include of fibers formed of fiberglass, polyamide, polyolefin, polyaramid, polyester, or any combination thereof. The barrier layers 304 or 306 can be formed of a barrier polymer, such as polyimide. In another example, the barrier polymer can include a fluoropolymer. The fluoropolymer can be ETFE. In another example, the fluoropolymer can be PVDF. In a further example, the fluoropolymer can be PVF. In an additional example, the fluoropolymer can be PTFE. The surface of the barrier layers 304 and 306 at interfaces 308 or 310 can be treated, such as corona or C-treated prior to lamination to the polymer layer 302.

In a further example, more than one barrier layers can be included on each side of a polymer layer. For example, barrier layers of different fluoropolymer can be included on a side of a polymer layer. As illustrated at FIG. 4, a polymer layer 402 is bonded directly to a barrier layer 418 at interface 408, which is bonded to a barrier layer 404. The polymer layer 402 can also be bonded to a barrier layer 420 at surface 410, and the barrier layer 420 can be bonded to a barrier layer 406. The polymer layer 402 can include a reinforcement material 416.

In an example, the barrier layer 418 includes a C-treatable fluoropolymer. The barrier layer 404 can also include a fluoropolymer. For example, a multilayer film can be formed of fluoropolymer materials, such as through coating a removable substrate with a layer to become barrier layer 404. Another layer to become barrier layer 418 can be coated onto the first layer. The barrier layer 418 can be C-treated at a surface to become the interface 408. The multilayer film can be laminated to the polymer layer 402. Similarly, layers 406 and 420 can be formed as described in relation to barrier layers 404 and 418.

In a particular embodiment, the barrier layer 404 or 406 can be formed of a polytetrafluoroethylene and the barrier layers 418 or 420 can be formed of an ethylene tetrafluoroethylene copolymer (ETFE), a fluorinated ethylene propylene copolymer, polyvinylidene fluoride (PVDF), polyvinylfluoride (PVF), or any combination thereof. For example, layer 404 can be formed of polytetrafluoroethylene (PTFE) and the barrier layer 418 can be formed of ETFE. In a related example, the barrier layer 418 can be formed of PVDF. In a further example, the barrier layer 418 can be formed of PVF. Optionally, barrier layers 406 or 420 can minor barrier layers 404 or 418, respectively. The surface of the barrier layers 418 or 420 at interfaces 410 or 408 can be treated, such as corona or C-treated prior to lamination to the polymer layer 402. In another example, the surface of the barrier layer 404 or 406 can be treated, such as corona treated or C-treated, prior to lamination to the barrier layer 418 or 420. The polymer layer 402 can include a polymeric material, such as described in relation to outer layers 104 and 106 of FIG. 1. For example, the polymer layer 402 can be formed of polyurethane. In another example, the polymer layer 402 can be formed of a polyolefin. The reinforcement material 416 can be a woven or knitted fabric, which can be formed of fibers formed of fiberglass, polyamide, polyolefin, polyaramid, polyester, or any combination thereof.

In another example, more than one barrier layer can form a core of the multilayer structure. For example, FIG. 5 includes an illustration of an exemplary multilayer structure 500 including a barrier layer 502 and a barrier layer 518 disposed on a surface 508 of the barrier layer 502. An outer layer 504 is disposed on surface 522. In an example, the barrier layer 518 at surface 522 is treated, such as C-treated. Surface 508 of barrier layer 502 can also be treated, such as C-treated.

Optionally, a barrier layer 520 can be formed on surface 510 of the barrier layer 502, and an outer layer 506 can be formed on a surface 524 of the barrier layer 520. The barrier layer at surface 524 can be treated, such as C-treated, and the surface 510 of barrier layer 502 can be treated, such as C-treated.

As illustrated at FIG. 5, the barrier layer 502 can encompass a reinforcement material 516. The reinforcement material 516 can be selected from the reinforcement materials described above. Alternatively, a reinforcement material can be incorporated in the outer layers 504 or 506. Such reinforcement material can be included in the outer layer and the barrier layer 502 can be free of the reinforcement material. The barrier layers 502, 518, or 520 can be formed of a barrier polymer, such as described above in relation to layer 102 of FIG.1. The outer layers 504 or 506 can be formed of the thermoset or thermoplastic polymer described above in relation to outer layers 104 and 106 of FIG. 1.

In an embodiment, the barrier layer 502 can be a fluoropolymer coated fabric encompassing fabric 516. For example, the barrier layer 502 can be a PTFE coated fabric and the barrier layer 518 or 520 can include ETFE or FEP. In another example, the barrier layer 518 or 520 can include PVDF or PVF. The surface of the barrier layers 518 or 520 at interfaces 522 or 524 can be treated, such as corona or C-treated prior to lamination to the outer layers 504 or 506. In another example, the surface of the barrier layer 502 can be treated, such as corona treated or C-treated, prior to lamination to the barrier layer 518 or 520. The reinforcement material 516 can be a woven or knitted fibrous material, which can be formed of fibers formed of fiberglass, polyamide, polyolefin, polyaramid, polyester, or any combination thereof. The outer layer 504 or 506 can include a thermoplastic polyurethane. In another example, the outer layer 504 or 506 can include a polyolefin.

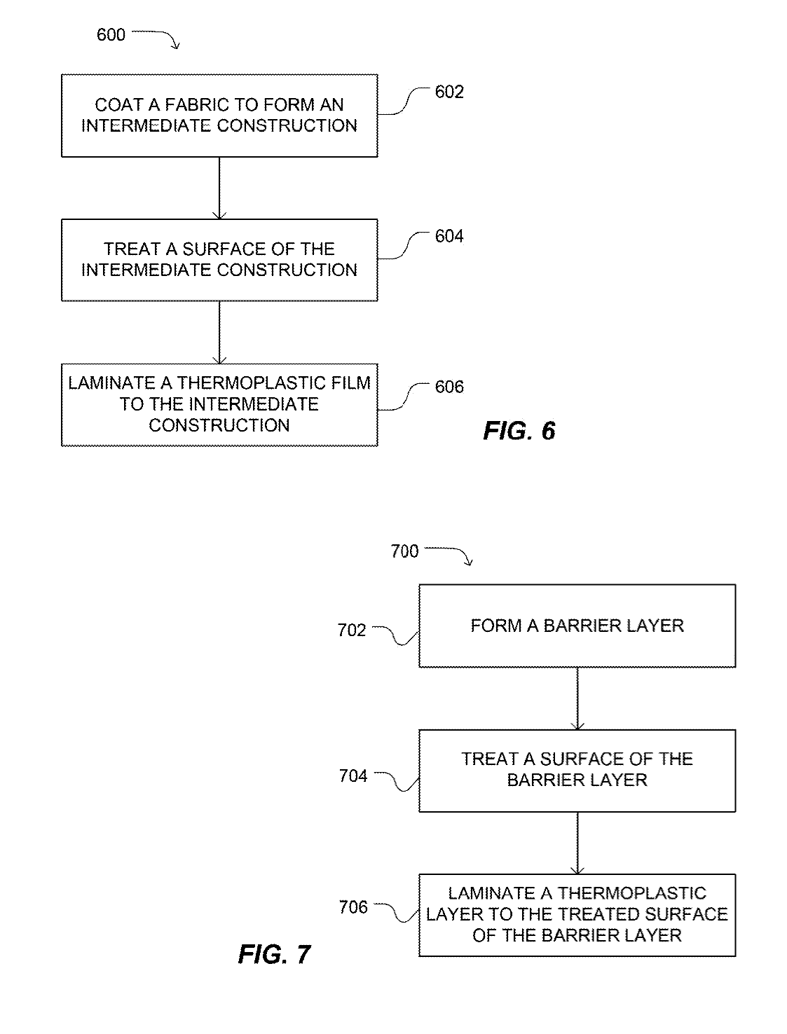

In an example, the multilayer structure can be formed by laminating a barrier layer to another polymer layer, such as a thermoplastic polymer layer, without intervening adhesive layers or metal or metal oxide coatings. In particular, the barrier layer can be surface treated, such as with a corona or C-treatment, prior to bonding to the polymer layer. For example, in the method 600 illustrated at FIG. 6, a reinforcement material, such as a woven or knitted fibrous material, can be coated with a barrier layer to form an intermediate construction, as illustrated at 602. In an example, the barrier layer can include a fluoropolymer. In another example, the barrier layer can include a polyimide. Alternatively, the barrier layer is formed without a reinforcement material, such as a on a removable carrier.

A surface of the intermediate construction can optionally be surface treated, such as corona or C-treated, as illustrated at 604. For example, a fluoropolymer barrier layer can be C-treated at a surface to be bonded to a thermoplastic layer.

The polymer layer, such as a thermoplastic layer, can be laminated to the intermediate construction, as illustrated at 606. The thermoplastic layer can, for example, include a reinforcement, such as woven fabric. For example, a thermoplastic layer can be applied to a treated surface of the intermediate construction, such as with heated rollers, or in batch process using a press. In the figures above, symmetric films and fabrics are illustrated and the additional layers can be laminated concurrently with the other layers or following lamination of the other layers. Alternatively, single sided films or fabrics can be formed or asymmetric films or fabrics can be formed using either the barrier layer or the polymer core layer as the center reference.

FIG. 7 includes an illustration of an exemplary method 700 in which a barrier layer is formed, as illustrated at 702. For example, the barrier layer can be formed on a carrier or can be extruded. In an example, the barrier layer is a polyimide layer. In another example, the barrier layer includes an extrudable fluoropolymer, such as PVDF, PVF, ETFE, or FEP. In another example, the barrier layer can be cast on a removable carrier, such as a cast PTFE film. Optionally, additional barrier layers can be formed on the barrier layer. For example, additional barrier layers can be cast over a first barrier layer. Alternatively, a multilayer barrier film can be formed through coextrusion.

As illustrated at 704, a surface of the barrier layer can be treated, such as through a treatment described above, in particular corona treatment, such as C-treatment. In particular, the surface to be laminated to a polymer layer can be treated. In a particular example, a surface of a fluoropolymer layer can be treated with a C-treatment.

The barrier layer can be laminated to a thermoplastic layer, as illustrated at 706. In an example, the thermoplastic layer can be a fabric coated with thermoplastic. For example, a thermoplastic layer can be applied to a treated surface of the barrier layer, such as with heated rollers, or in batch process using a press. Additional barrier layers can be laminated to the thermoplastic layer opposite the barrier layer. Alternatively, additional thermoplastic layers can be laminated to a surface of the barrier layer opposite the first thermoplastic layer. In the figures above, symmetric films and fabrics are illustrated and the additional layers can be laminated concurrently with the other layers or following lamination of the other layers. Alternatively, single sided films or fabrics can be formed or asymmetric films or fabrics can be formed using either the barrier layer or the polymer core layer as the center reference. Multiple layers can be laminated concurrently.

Once formed, particular embodiments of the above-disclosed multilayer structure advantageously exhibit desired properties such as improved chemical barrier properties and flammability resistance. In an example, the multilayer structure may have a chemical permeation breakthrough time of greater than about one hour for hazardous chemicals, as measured in accordance with ASTM F739. In an example, the multilayer structure may have a chemical permeation breakthrough time of greater than about three hours for hazardous chemicals, as measured in accordance with ASTM F739. In a further example, the multilayer structure meets the chemical permeation standards set by NFPA 1991 as measured in accordance with ASTM F 739. For example, the multilayer structure meets the chemical permeation standards set by NFPA 1991 in Section 7.2.1 as measured in accordance with ASTM F 739 for hazardous chemicals such as acetone, acetonitrile, ammonia gas, 1,3-butadiene, carbon disulfide, chlorine gas, dichloromethane, diethylamine, dimethyl formamide, ethyl acetate, ethylene oxide, hexene, hydrogen chloride gas, methanol, methyl chloride gas, nitrobenzene, sodium hydroxide, sulfuric acid, tetrachloroethylene, tetrahydrofuran, and toluene. Chemical breakthrough time is defined as being the point at which the permeation rate reaches or exceeds 0.1 μg/cm²/min. Herein, the permeant is toluene. For example, the chemical permeation breakthrough can be at least 1 hour, such as at least 3 hours, or even at least 8 hours. In an example, the multilayer structure has a chemical permeation breakthrough to Fuel B (a mixture of about 70% by volume isooctane and about 30% by volume toluene) of less than about 10 grams/meters²/day as measured in accordance with ASTM D814-95.

In an example, the multilayer structures have a flammability resistance such that they do not ignite in the 3 second flame exposure component of ASTM F1358. In a further example, the multilayer structure meets the flammability resistance standards set by NFPA 1991. For example, the multilayer structure meets the flammability resistance standards set by NFPA 1991 in Section 7.2.2 as measured in accordance with ASTM F1358 wherein suit materials shall not ignite during the initial 3-second exposure period, shall not burn a distance of greater than 100 mm (4 in.), shall not sustain burning for more than 10 seconds, and shall not melt as evidenced by flowing or dripping during the subsequent 12-second exposure period, i.e. no melt.

In an example, the multilayer structure may exhibit desirable anti-static properties. In a particular example, the multilayer structure may have a surface resistivity of less than about 10⁶ Ohms, such as less than about 10⁵ Ohms, as measured in accordance with ASTM D257.

In an example, the multilayer structure may exhibit desirable burst strength and puncture propagation tear resistance. For instance, the multilayer structure may have a burst strength of at least about 200N, when tested in accordance with the ring clamp method in ASTM D751. In particular, the burst strength may be greater than about 200N, such as greater than about 300N, such as greater than about 500N, or even greater than about 600N. In an example, the multilayer structure may have a puncture propagation tear resistance of greater than about 49N, when tested in accordance with ASTM D2582. In particular, the puncture propagation tear resistance may be greater than about 60N, such as greater than about 100N, or even greater than about 150 N, as measured in accordance with ASTM D2582.

In an example, the multilayer structure may exhibit a desirable seam strength when seamed. For instance, the multilayer structure may have a seam strength of greater than about 15 lb/in, such as greater than about 25 lb/in, or even greater than about 40 lb/in, when tested in accordance with ASTM D751.

In an example, the multilayer structure may exhibit a desirable cold bending moment. In particular, the cold bending moment may be not greater than about 0.050 Nm, such as not greater than about 0.025 Nm, or even not greater than about 0.010 Nm at −25° C., when tested in accordance with ASTM D747.

In an example, the multilayer structure may exhibit a desirable tensile strength. For instance, the multilayer structure may have a tensile strength of at least about 1.5 kN/m, such as at least about 3.0 kN/m, when tested in accordance with ASTM D751. In an example, the multilayer structure has both a chemical permeation resistance of greater than about one hour for hazardous chemicals, when measured by ASTM F739, and a burst strength of at least about 200N, when measured by ASTM D751. In another example, the multilayer structure has both a chemical permeation resistance of greater than about one hour for hazardous chemicals, when measured in accordance with ASTM F739, and a tensile strength of at least about 3.0 kN/m, when measured in accordance with ASTM D751.

Multilayer structures made of the layers described above may have numerous applications. In an example, the multilayer structure may be faced with thermoplastic polymers. As stated earlier, seams can be readily made with the multilayer structures, making it suitable for fabrication into various articles that generally take advantage of their barrier properties. Manufacturing and materials selection flexibility imparted by relatively low temperature seaming methods, coupled with the chemical barrier properties of fluoropolymer films, is a novel contribution to many potential markets.

Applications include, for example, uses when the properties such as the above-mentioned burst strength, tensile strength, tear resistance, anti-static properties, chemical permeation, and/or flammability resistance are desired. For instance, the multilayer structure may be used when a chemical and/or biological resistant material is desired. In an example, exemplary multilayer structures include shelters, liners, protective gear, clothing, and fluid containment systems. The structure may also possess other properties desired for any particular application envisioned. Furthermore, the multilayer structures include architectural applications such as roofing, shelters, and shades. In a particular example, the multilayer structures may be used for applications such as antenna covers and packaging material.

In an example, protective articles are made from the multilayer structures, such as suits and soft shelters. The protective articles make use of particular embodiments' low permeability to hazardous chemicals. In another example, the protective article has both a chemical permeation resistance of greater than about one hour for hazardous chemicals, when measured by ASTM F739, and a flame resistance of non-ignition in the 3 second flame exposure, when measured by ASTM F1358. Other properties such as flame resistance and mechanical properties are typically desired, as set out in specifications and industry standards such as NFPA 1991.

Containment articles, such as portable personal hydration systems, may be fabricated in whole or in part from these multilayer structures. Such articles take advantage of the chemical barrier properties to protect the fluid within, while the surface polymeric layers may be selected as needed for appearance or performance, with the proviso that the interior facing polymeric layer must be suitable for contact with drinking water.

Other containment systems can be envisioned, wherever chemical or biological barrier properties are desired, such as for transportation and/or storage of potentially hazardous chemical or biological materials. In an example, the multilayer structure has exemplary anti-static properties to chemical and/or hazardous materials. In a particular example, the containment system can be used as liners for tanks that contain chemical and/or biological materials. For instance, exemplary tanks include septic tanks, fuel tanks, food tanks, water tanks, and the like. In an example, the containment system can be a floating roof seal for tanks containing potentially hazardous materials.

In a first embodiment, a multilayer construction includes a barrier layer having first and second major surfaces and including a polyimide material; a first outer layer directly bonded to and in direct contact with the first major surface of the barrier layer, the first outer layer comprising a thermoplastic polymer; and a second outer layer directly bonded to and in direct contact with the second major surface of the barrier layer, the second outer layer comprising the thermoplastic polymer. The first and second outer layers form first and second opposite outer surfaces of the multilayer construction.

In an example of the first embodiment, the first outer layer includes a reinforcement material, the thermoplastic polymer coating the reinforcement material. The reinforcement material can include a woven fabric. In another example, the reinforcement material can include a nonwoven fabric. In a further example, the reinforcement material includes a knitted fabric.

In another example of the first embodiment and the preceding examples, the second outer layer includes a reinforcement material. The thermoplastic polymer coats the reinforcement material.

In a further example of the first embodiment and the preceding examples, the thermoplastic polymer includes polyurethane. Alternatively, the thermoplastic polymer includes polyolefin.

In an additional example of the first embodiment and the preceding examples, the multilayer construction exhibits a chemical permeation breakthrough of at least 1 hour when exposed to toluene, such as at least 3 hours when exposed to toluene.

In an example of the first embodiment and the preceding examples, the multilayer construction does not ignite with a 3 second exposure to an open flame. In an additional example of the first embodiment and the preceding examples, the multilayer construction has a surface resistance of not greater than 10⁶ ohms.

In another example of the first embodiment and the preceding examples, the multilayer construction exhibits a burst strength of at least 200 N. In a further example of the first embodiment and the preceding examples, the multilayer construction exhibits a seam strength of at least 15 lb/in. In an example of the first embodiment and the preceding examples, the multilayer construction exhibits a cold bend moment of not greater than 0.05 Nm at −25° C. In an additional example of the first embodiment and the preceding examples, the multilayer construction exhibits a tensile strength of at least 1.5 kN/m.

In a second embodiment, a multilayer construction includes a barrier layer having first and second major surfaces and including a fluoropolymer, the first and second major surfaces being treated surfaces; a first outer layer bonded directly to an in direct contact with the first major surface of the barrier layer, the first outer layer comprising a reinforcement material coated with a thermoplastic polymer; and a second outer layer bonded directly to and in direct contact with the second major surface of the barrier layer, the second outer layer comprising the reinforcement material coated with the thermoplastic polymer. The first and second outer layers form first and second opposite major surfaces of the multilayer construction.

In an example, of the second embodiment, the first and second major surfaces are corona treated, UV treated, electron beam treated, flame treated, scuffed, sodium naphthalene surface treated, or any combination thereof. For example, the first and second major surfaces are corona treated, such as c-treated.

In an additional example of the second embodiment and the preceding examples, the fluoropolymer includes polytetrafluoroethylene (PTFE), ethylene tetrafluoroethylene copolymer (ETFE), polyvinylidene fluoride (PVDF), polyvinyl fluoride (PVF), fluorinated ethylene propylene copolymer (FEP), or any combination thereof.

In a further example of the second embodiment and the preceding examples, the thermoplastic polymer includes polyurethane. Alternatively, the thermoplastic polymer includes polyolefin.

In another example of the second embodiment and the preceding examples, the reinforcement material includes a fabric. For example, the fabric can be a woven fabric. In another example, the fabric can be a nonwoven fabric. In a further example, the fabric is a knitted fabric.

In an additional example of the second embodiment and the preceding examples, the multilayer construction exhibits a chemical permeation breakthrough of at least 1 hour, such as at least 3 hours, or even at least 8 hours.

In an example, the multilayer construction does not ignite with a 3 second exposure to flame. In an additional example of the second embodiment and the preceding examples, the multilayer construction has a surface resistance of not greater than 10⁶ ohms. In a further example of the second embodiment and the preceding examples, the multilayer construction exhibits a burst strength of at least 200 N. In another example of the second embodiment and the preceding examples, the multilayer construction exhibits a seam strength of at least 15 lb/in.

In a further example of the second embodiment and the preceding examples, the multilayer construction exhibits a cold bend moment of not greater than 0.05 Nm at −25° C. In an additional example of the second embodiment and the preceding examples, the multilayer construction exhibits a tensile strength of at least 1.5 kN/m.

In a third embodiment, a multilayer construction includes a first barrier layer comprising a fluoropolymer; a second barrier layer bonded directly to an in direct contact with a major surface of the first barrier layer, the second barrier layer having a treated surface disposed opposite the first barrier layer ; a thermoplastic layer bonded directly to an in direct contact with the treated surface of the second barrier layer, the thermoplastic layer coating a reinforcement material; and the reinforcement material.

In an example of the third embodiment, the multilayer construction further includes a third barrier layer bonded directly to an in direct contact with a second major surface of the first barrier layer opposite the second barrier layer, the third barrier layer having a treated surface dispose opposite the first barrier layer; and a second thermoplastic layer bonded directly to an in direct contact with the treated surface of the third barrier layer. In a further example, the multilayer construction further includes a second reinforcement material, the second thermoplastic layer coating the second reinforcement material.

In another example of the third embodiment, the multilayer construction further includes a third barrier layer comprising the fluoropolymer; and a fourth barrier layer bonded directly to an in direct contact with a surface of the third barrier layer, the fourth barrier layer having a treated surface opposite the third barrier layer, the thermoplastic layer bonded directly to an in direct contact with the treated surface of the fourth barrier layer at a surface opposite the second barrier layer.

In a further example of the third embodiment and preceding examples, the second barrier layer includes a second fluoropolymer different from the fluoropolymer. For example, the second fluoropolymer can include polytetrafluoroethylene (PTFE), ethylene tetrafluoroethylene copolymer (ETFE), polyvinylidene fluoride (PVDF), polyvinyl fluoride (PVF), fluorinated ethylene propylene copolymer (FEP), or any combination thereof. In a particular example, the fluoropolymer includes a perfluoropolymer. In another example, the fluoropolymer includes polytetrafluoroethylene (PTFE), ethylene tetrafluoroethylene copolymer (ETFE), polyvinylidene fluoride (PVDF), polyvinyl fluoride (PVF), fluorinated ethylene propylene copolymer (FEP), or any combination thereof.

In an additional example of the third embodiment and preceding examples, the treated surface is corona treated, UV treated, electron beam treated, flame treated, scuffed, sodium naphthalene surface treated, or any combination thereof. For example, the treated surface is corona treated, such as c-treated.

In another example of the third embodiment and preceding examples, the thermoplastic layer includes a thermoplastic polymer, thermoplastic polymer including polyurethane. In a further example of the third embodiment and preceding examples, the thermoplastic layer includes a thermoplastic polymer, thermoplastic polymer including polyolefin.

In an additional example of the third embodiment and preceding examples, the reinforcement material includes a fabric. For example, the fabric is a woven fabric. In another example, the fabric is a nonwoven fabric. In an additional example, the fabric is a knitted fabric.

In an example of the third embodiment and preceding examples, the multilayer construction exhibits a chemical permeation breakthrough of at least 1 hour, such as at least 3 hours.

In a further example of the third embodiment and preceding examples, the multilayer construction does not ignite with a 3 second exposure to an open flame. In an additional example of the third embodiment and preceding examples, the multilayer construction has a surface resistance of not greater than 10⁶ ohms.

In an additional example of the third embodiment and preceding examples, the multilayer construction exhibits a burst strength of at least 200 N. In an example of the third embodiment and preceding examples, the multilayer construction exhibits a seam strength of at least 15 lb/in.

In another example of the third embodiment and preceding examples, the multilayer construction exhibits a cold bend moment of not greater than 0.05 Nm at −25° C. In a further example of the third embodiment and preceding examples, the multilayer construction exhibits a tensile strength of at least 1.5 kN/m.

In a fourth embodiment, a method of forming a multilayer barrier construction includes forming a barrier layer comprising a fluoropolymer; treating a surface of the barrier layer; and laminating a thermoplastic polymer layer to the treated surface of the barrier layer, the thermoplastic polymer layer bonded directly to and directly contacting the treated surface of the barrier layer.

In an example of the fourth embodiment, the multilayer barrier construction further includes treating a second surface of the barrier layer and laminating a second thermoplastic polymer layer to second surface of the barrier layer, the second thermoplastic polymer layer bonded directly to and directly contacting the second surface of the barrier layer.

In another example of the fourth embodiment and the preceding examples, forming the barrier layer includes coating a reinforcement material. For example, the reinforcement material includes a woven fabric. In another example, the reinforcement material includes a nonwoven fabric. In a further example, the reinforcement material includes a knitted fabric.

In an additional example of the fourth embodiment and the preceding examples, treating the surface includes at least one of corona treating, UV treating, electron beam treating, flame treating, scuffing, or sodium naphthalene surface treating. For example, treating the surface includes corona treating, such as c-treating.

In a further example of the fourth embodiment and the preceding examples, laminating includes heating and pressing. In an example of the fourth embodiment and the preceding examples, the thermoplastic layer includes a reinforcement material. For example, the reinforcement material includes a woven fabric. In another example, the reinforcement material includes a nonwoven fabric. In a further example, the reinforcement material includes a knitted fabric.

In a fifth embodiment, a method of forming a multilayer barrier construction includes forming a barrier layer having first and second opposite major surfaces and comprising a polyimide; laminating a first thermoplastic polymer layer to a first major surface of the barrier layer; and laminating a second thermoplastic layer to a second major surface of the barrier layer, the first and second thermoplastic layers forming outer surfaces of the multilayer barrier construction.

In an example of the fifth embodiment, the first thermoplastic polymer layer coats a first reinforcement material. In another example of the fifth embodiment and the preceding examples, the second thermoplastic polymer layer coats a second reinforcement material. In an additional example of the fifth embodiment and the preceding examples, the barrier layer coats a reinforcement material.

In a further example of the fifth embodiment and the preceding examples, laminating includes heating and pressing the first or second thermoplastic layer to the barrier layer. In an additional example, of the fifth embodiment and the preceding examples, laminating the first thermoplastic layer and laminating the second thermoplastic layer occur concurrently.

In a sixth embodiment, a multilayer construction includes a barrier layer having first and second major surfaces and including a liquid crystal polymer; a first outer layer directly bonded to and in direct contact with the first major surface of the barrier layer, the first outer layer comprising a thermoplastic polymer; and a second outer layer directly bonded to and in direct contact with the second major surface of the barrier layer, the second outer layer comprising the thermoplastic polymer. The first and second outer layers form first and second opposite outer surfaces of the multilayer construction.

In an example of the sixth embodiment, the first outer layer includes a reinforcement material, the thermoplastic polymer coating the reinforcement material. For example, the reinforcement material includes a woven fabric. In another example, the reinforcement material includes a nonwoven fabric. In an additional example, the reinforcement material includes a knitted fabric.

In another example of the sixth embodiment and the preceding examples, the second outer layer includes a reinforcement material, the thermoplastic polymer coating the reinforcement material.

In a further example of the sixth embodiment and the preceding examples, the thermoplastic polymer includes polyurethane. In another example of the sixth embodiment and the preceding examples, the thermoplastic polymer includes polyolefin.

In an additional example of the sixth embodiment and the preceding examples, the multilayer construction exhibits a chemical permeation breakthrough of at least 1 hour when exposed to toluene, such as at least 3 hours when exposed to toluene.

In another example of the sixth embodiment and the preceding examples, the multilayer construction does not ignite with a 3 second exposure to an open flame. In a further example of the sixth embodiment and the preceding examples, the multilayer construction has a surface resistance of not greater than 10⁶ ohms. In an additional example of the sixth embodiment and the preceding examples, the multilayer construction exhibits a burst strength of at least 200 N. In an example of the sixth embodiment and the preceding examples, the multilayer construction exhibits a seam strength of at least 15 lb/in. In another example of the sixth embodiment and the preceding examples, the multilayer construction exhibits a cold bend moment of not greater than 0.05 Nm at −25° C. In a further example of the sixth embodiment and the preceding examples, the multilayer construction exhibits a tensile strength of at least 1.5 kN/m.

Note that not all of the activities described above in the general description or the examples are required, that a portion of a specific activity may not be required, and that one or more further activities may be performed in addition to those described. Still further, the orders in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A multilayer construction comprising:
a barrier layer having first and second major surfaces and including a polyimide material;
a first outer layer directly bonded to and in direct contact with the first major surface of the barrier layer, the first outer layer comprising a thermoplastic polymer; and
a second outer layer directly bonded to and in direct contact with the second major surface of the barrier layer, the second outer layer comprising the thermoplastic polymer;
wherein the first and second outer layers form first and second opposite outer surfaces of the multilayer construction.

2. The multilayer construction of claim 1, wherein the first outer layer includes a reinforcement material, the thermoplastic polymer coating the reinforcement material.

3.-5. (canceled)

6. The multilayer construction of claim 1, wherein the second outer layer includes a reinforcement material, the thermoplastic polymer coating the reinforcement material.

7.-11. (canceled)

12. The multilayer construction of claim 1, wherein the multilayer construction has a surface resistance of not greater than 10⁶ ohms.

13. The multilayer construction of claim 1, wherein the multilayer construction exhibits a burst strength of at least 200 N.

14. The multilayer construction of claim 1, wherein the multilayer construction exhibits a seam strength of at least 15 lb/in.

15. The multilayer construction of claim 1, wherein the multilayer construction exhibits a cold bend moment of not greater than 0.05 Nm at −25° C.

16. The multilayer construction of claim 1, wherein the multilayer construction exhibits a tensile strength of at least 1.5 kN/m.

17. A multilayer construction comprising:
a barrier layer having first and second major surfaces and including a fluoropolymer, the first and second major surfaces being treated surfaces;
a first outer layer bonded directly to an in direct contact with the first major surface of the barrier layer, the first outer layer comprising a reinforcement material coated with a thermoplastic polymer;
a second outer layer bonded directly to and in direct contact with the second major surface of the barrier layer, the second outer layer comprising the reinforcement material coated with the thermoplastic polymer; and
wherein the first and second outer layers form first and second opposite major surfaces of the multilayer construction.

18. The multilayer construction of claim 17, wherein the first and second major surfaces are corona treated, UV treated, electron beam treated, flame treated, scuffed, sodium naphthalene surface treated, or any combination thereof.

19.-20. (canceled)

21. The multilayer construction of claim 17, wherein the fluoropolymer includes polytetrafluoroethylene (PTFE), ethylene tetrafluoroethylene copolymer (ETFE), polyvinylidene fluoride (PVDF), polyvinyl fluoride (PVF), fluorinated ethylene propylene copolymer (FEP), or any combination thereof.

22. The multilayer construction of claim 17, wherein the thermoplastic polymer includes polyurethane.

23. (canceled)

24. The multilayer construction of claim 17, wherein the reinforcement material includes a fabric.

25.-27. (canceled)

28. The multilayer construction of claim 17, wherein the multilayer construction exhibits a chemical permeation breakthrough of at least 1 hour.

29.-32. (canceled)

33. The multilayer construction of claim 17, wherein the multilayer construction exhibits a burst strength of at least 200 N.

34. (canceled)

35. The multilayer construction of claim 17, wherein the multilayer construction exhibits a cold bend moment of not greater than 0.05 Nm at −25° C.

36.-81. (canceled)

82. A multilayer construction comprising:
a barrier layer having first and second major surfaces and including a liquid crystal polymer;
a first outer layer directly bonded to and in direct contact with the first major surface of the barrier layer, the first outer layer comprising a thermoplastic polymer; and
a second outer layer directly bonded to and in direct contact with the second major surface of the barrier layer, the second outer layer comprising the thermoplastic polymer;
wherein the first and second outer layers form first and second opposite outer surfaces of the multilayer construction.

83. The multilayer construction of claim 82, wherein the first outer layer includes a reinforcement material, the thermoplastic polymer coating the reinforcement material.

84.-87. (canceled)

88. The multilayer construction of claim 82, wherein the thermoplastic polymer includes polyurethane.

89. The multilayer construction of claim 82, wherein the thermoplastic polymer includes polyolefin.

90.-97. (canceled)
